(19) United States
(12) Patent Application Publication
(10) Pub. No.: US 2012/0165455 A1
(43) Pub. Date: Jun. 28, 2012

(54) OBC Based Packaging Adhesive

(75) Inventors: Michael Vitrano, West Allis, WI (US); Kevin Stafeil, Delafield, WI (US)

(73) Assignee: BOSTIK, INC., Wauwatosa, WI (US)

(21) Appl. No.: 13/334,464

(22) Filed: Dec. 22, 2011

Related U.S. Application Data
(60) Provisional application No. 61/425,929, filed on Dec. 22, 2010.

(51) Int. Cl. C08L 53/00

(52) U.S. Cl. 524/505

(57) ABSTRACT

A hot melt adhesive formulation utilizing a blend of polymers which include a polyolefin polymer and an olefinic block copolymer (OBC). The hot melt formulations demonstrate improved hot tack, adhesion, and bond line flexibility over other traditional hot melt adhesives.

### CROSS REFERENCE TO RELATED APPLICATIONS

The present application claims the benefit of priority under 35 U.S.C §119(e) to U.S. Provisional Application No. 61/425,929 filed on Dec. 22, 2010, the content of which is incorporated herein by reference in its entirety.

### FIELD OF THE INVENTION

The present invention relates to hot melt adhesives, and more specifically to a hot melt adhesive formulation utilizing a blend of polymers which include a polyolefin polymer and an olefinic block copolymer (OBC). The hot melt formulations in this invention demonstrate improved hot tack, adhesion, and bond line flexibility over other traditional hot melt adhesives.

### BACKGROUND INFORMATION

Adhesives used in applications in which manufactured goods are packaged, are often required to adhere to a wide range of inks, coatings, and overprint lacquers. The substrates themselves can also vary in physical characteristics, such as rigidity, density, and chemical make-up. As a result, adhesives must be formulated to overcome these obstacles. Consequently, adhesive formulators are continuously evaluating new materials and novel formulation strategies in order to develop an adhesive with the broadest possible application window. An adhesive's application window is defined as an adhesive's ability to overcome an application's deficiencies and/or manufacturing variables. The current invention details a novel way a hot melt formulator can improve an adhesive's application window through improved hot tack, adhesion, and cold temperature flexibility without affecting an adhesive's high temperature environmental resistance.

Polyethylene based hot melts have been used for many years in applications such as case and carton sealing, pinch bottom bag closure, hot melt glue sticks, etc. Historically, adhesive formulators have struggled to formulate a crystalline, polyethylene based adhesive that would have good hot tack and/or acceptable cold temperature performance. While polyethylene based hot melt adhesives in general provide relatively good elevated temperature resistance their low temperature performance and hot tack properties are less than desired.

Traditionally, if hot tack or cold temperature resistance were needed for the application, adhesive formulators would utilize a different polymer chemistry, for example an ethylene vinyl acetate (EVA) copolymer. As a result, adhesive formulators and raw material suppliers alike have strived to bridge the gap between the high temperature resistance provided by a crystalline, polyethylene based adhesive and the hot tack and cold temperature resistance that an EVA copolymer based adhesive offers.

Over the years, adhesive formulators have utilized a variety of different polymers as well as other additives in their formulations to obtain a balance of these attributes. These polymers include, but are not limited to polyolefins (ethylene- or propylene-based polymers), functionalized polyolefins (ethylene or propylene copolymers with oxygen containing monomers), or amorphous poly alpha-olefins (APAO) (ethylene-, propylene-, or butene copolymers). However, when formulated into hot melt adhesives, these polymers had certain performance deficiencies. For example, due to their overall wide molecular weight distribution and/or significant low molecular weight portion as observed by various analytical testing methods, APAOs can provide flexibility but can hamper bonding performance at elevated temperatures. In fact, their amorphous, non-crystalline structure can often lead to blocking. Blocking is defined as the undesired adhesion of a coated adhesive to substrates it comes into contact with during shipping and/or storage.

In addition to ethylene vinyl acetate (EVA) copolymers other polymers have also been utilized in an attempt to improve an adhesive's hot tack and adhesion characteristics. These polymers include, but are not limited to ethylene methyl acrylate copolymers (EMA), ethylene n-butyl acrylate (EnBA), and ethylene methyl acrylate acrylic acid copolymers. These polymers exhibit narrower poly-dispersity when compared to olefin polymers, such as APAO and have lower overall melt peaks as observed by DSC (Differential Scanning calorimetry). This results in an adhesive that is prone to blocking or bond failure at elevated temperatures if not reinforced with some other crystalline additive. While the incorporation of certain waxes or other crystalline additives can increase the elevated temperature resistance of the adhesive, they can reduce the adhesive's hot tack, adhesion, and flexibility.

Adhesive formulators may incorporate other additives or diluents to promote adhesion and flexibility, including but not limited to various plasticizers, microcrystalline waxes, and vinyl acetate or maleic anhydride modified waxes. As substrates become increasingly difficult to adhere, due to higher recycled content, coatings, and impregnated films, high utilization of these materials have been shown to negatively affect adhesion.

Polyolefin polymers are produced with a very wide range of molecular weights, monomers, densities, and crystallinity levels. Recently, metallocene catalysts have been used to make polyolefins with more precisely tailored properties. For example, the molecular weight of the polymer can be controlled in a way not possible with the older Ziegler-Natta catalysts. Traditional polyethylene based adhesives were made using this type of technology. The newer polymers can be made using high levels of comonomer, such as butene-1 and octene-1, to produce polymers with very low levels of crystallinity and density. While these polymers can be used to make hot melt adhesives with better adhesion characteristics, they exhibit many of the melt profile characteristics that traditional ethylene vinyl acetate copolymers possess. Although novel in design, the formulation strategies and benefits, when using these materials, are not unlike those that can be obtained through traditional EVA based systems in most cases. Examples of these metallocene polymers include Affinity® and Engage® polymers from Dow Chemical Company. Polymers and adhesives of this type are described in U.S. Pat. Nos. 6,107,430 and 6,319,979.

A more recent development in the area of polyolefins is referred to as “olefin block copolymers” or OBC. This is an entirely new class of polyolefin polymers produced using a chain shuttling catalysis technology that produces a linear block structure of the monomers rather than a random polymer produced by Ziegler-Natta or traditional metallocene technology. At this time, they are manufactured by Dow Chemical under the trade name of Infuse®. The OBC polymers consist of crystallizable ethylene-octene blocks (hard) with very low comonomer content and high melting point alternating with amorphous ethylene-octene blocks (soft) with high comonomer content and low glass transition temperature. This gives the polymer much better elevated temperature resistance and elasticity compared to a typical metallocene random polymer of similar density. These polymers are described in WO 2006/101966 and others assigned to Dow Chemical Co.

Olefin block copolymers should not be considered amorphous poly-alpha-olefins because the polymer architecture is completely different (i.e. block vs. random) and is specifically produced to have crystalline regions. In addition, OBCs are significantly narrower in poly-dispersity than other traditionally used olefins which impacts their melt profiles as measured by DSC (Differential Scanning calorimetry). It is these structural differences, in combination with the narrow poly-dispersity of OBCs that provides a hot melt adhesive with improved hot tack, adhesion, and cold temperature flexibility without affecting its overall high temperature resistance.

### SUMMARY OF THE INVENTION

The invention is based on the use of olefin block copolymers in hot melt adhesives for applications that require increased hot tack, adhesion, and flexibility.

The invention details hot melt adhesive formulations, consisting of a thermoplastic base polymer, tackifying resin, olefin block copolymer (OBC), and in some cases wax. These formulations provide superior hot tack, adhesion characteristics, and flexibility over crystalline, polyethylene based adhesives used specifically, but not limited to Rigid Packaging applications, Multiwall Bag applications, non-structural Assembly applications, Graphic Arts applications, Craft, and/or Floral applications.

### DESCRIPTION OF THE INVENTION

It has been discovered that OBCs can be incorporated into hot melt adhesive formulas that exhibit increased hot tack, adhesion characteristics, and flexibility.

The OBC polymer is blended with another polymer such as polyethylene to modify the adhesive's properties. The OBC serves to improve the low temperature adhesion and flexibility of the adhesive without detracting from the elevated temperature performance. Historically, polyethylene was blended with APAO to improve the flexibility of the adhesive. However, the APAO decreased the elevated temperature resistance of the adhesive.

Olefin block copolymers are an entirely new class of polyolefin polymer produced using a chain shuttling catalysis technology that produces a linear block structure of the monomers rather than a random polymer produced by Ziegler-Natta or traditional metallocene technology. At this time, they are manufactured by Dow Chemical under the trade name of Infuse®. The OBC's consist of crystallizable ethylene-octene blocks (hard) with very low comonomer content and high melting temperature alternating with amorphous ethylene-octene blocks (soft) with high comonomer content and low glass transition temperature. This gives the polymer much better elevated temperature resistance and elasticity compared to a typical metallocene random polymer of similar density. While some of the grades of Infuse® have low heat of fusion (approximately 20 Joules/gram) they could not be considered to be amorphous poly-alpha-olefins because the polymer architecture is completely different (i.e. block vs. random) and is specifically produced to have crystalline regions. Not only are they different on a structural basis, they are very different from a physical property standpoint with the OBC's having better elastic recovery, compression set and elevated temperature resistance. As such, they are sold into different markets for different end uses and are not considered equivalent for one another.

OBCs are well known in the art. Details of their synthesis and physical properties can be found in, for example, WO 2006/101966, WO 2006/102016, WO 2006/102150, WO 2009/029476 and U.S. Pat. No. 7,524,911, the disclosures of which are specifically incorporated herein by reference. As is known in the art, the density of the OBC is directly related to its crystallinity, i.e. the higher the density the higher the percent crystallinity. OBC's useful in the present hot melt adhesive composition have densities ranging from 0.860 g/cm³ to 0.890 g/em³ (g/cc) and a melt index of 1 g/10 min. to 1000 g/10 min, preferably 1 g/10 min to 100 g/10 min. as measured according to ASTM. D1238 at 0.190° C. with a 2.16 kg weight.

Blends of two or more OBC polymers may also be used. For example, a blend of a first OBC polymer and a second OBC polymer that is different than the first OBC polymer may be employed.

OBC polymers are commercially available from Dow Chemical Company under the tradename “Infuse™” in different grades which are distinguishable primarily based on their density and weight percent crystallinity as follows:

| | | Melt Index |
|---|---|---|
| | Density | (190° C., 2.16 kg), |
| OBC Grade | (grams/cc) | g/10 min |
| Infuse ™ 9817 | 0.877 | 15 |
| Infuse ™ 9807 | 0.866 | 15 |
| Infuse ™ 9530 | 0.887 | 5 |
| Infuse ™ 9500 | 0.877 | 5 |
| Infuse ™ 9507 | 0.866 | 5 |

Other grades of Infuse™ polymer are commercially available, but these are best suited for hot melt adhesives since they have the highest melt index.

U.S. Pat. No. 7,524,911 and WO 2009/029476 disclose adhesive compositions based on olefin block copolymers (OBC). Other references disclosing OBC's and various applications for OBC's include WO 2006/101966, WO 2006/102016, WO 2008/005501, and WO 2008/067503.

The OBC copolymer may be incorporated into the composition in amounts of from about 2% to about 50% by weight, preferably from about 5% to about 30% by weight, and most preferably from about 5% to about 20% by weight.

Although the examples which follow show blends of polyethylene with the OBC, other primary base polymers could also be used such as polypropylene, ethylene vinyl acetate copolymers, propylene/ethylene copolymers, ethylene/alpha-olefin copolymers, ethylene n-butyl acrylate copolymers, etc.

More specifically the base polymer may be composed of a thermoplastic material or blends of thermoplastic materials which are preferably selected from the group consisting of polyolefins, acrylic modified polyolefins, vinyl acetate modified polyolefins, and acrylic polymers. The polyolefin may be polypropylene or polyethylene. The acrylic modified polyolefin may be a copolymer of polypropylene or polyethylene and an acrylic. Likewise, the vinyl acetate modified polyolefin may be a copolymer of polypropylene or polyethylene and vinyl acetate.

The polyolefin polymer may be incorporated into the composition in amounts of from about 20% to about 70% by weight, preferably from about 30% to about 70% by weight, and most preferably from about 30% to about 60% by weight.

The thermoplastic base polymer may also be a suitable single site or metallocene catalyzed ethylene-based copolymer comprising a major portion by weight of ethylene and a minor portion by weight of a C₃ to C₁₈ alpha-olefin comonomer, or a single site or metallocene catalyzed propylene-based copolymer comprising a major portion by weight of propylene and a minor portion by weight of a C₁ to C₁₈ alpha-olefin comonomer, or a blend of the ethylene-based copolymers, the propylene-based copolymers, or one or more of the ethylene-based copolymers with one or more of the propylene-based copolymers. The alpha-olefin comonomer preferably contains 3 to 12 carbon atoms, more preferably contains 4 to 10 carbon atoms, and most preferably contains 4 to 8 carbon atoms. More particularly, the alpha-olefin comonomer may be selected from 1-butene, 1-pentene, 3-methyl-1-butene, 3-methyl-1-pentene, 1-hexene, 4-methyl-1-pentene, 1-dodecene, 3-methyl-1-hexene, 1-octene, and 1-decene. Particularly preferred is 1-butene or 1-octene copolymerized with ethylene:

The alpha-olefin comonomer content in the ethylene-based copolymer is at least 20% by weight and in the range of from 20% to 50% by weight, preferably from 25% to 50% by weight, more preferably from 30% to 50% by weight. Suitable ethylene-based copolymers have a density as determined by ASTM D-792 of 0.90 g/cm³ or less and in the range of from 0.90 g/cm³ to 0.85 g/cm³, preferably between 0.89 g/cm³ and 0.85 g/cm³, and most preferably between 0.885 g/cm³ and 0.85 g/cm³. Suitable ethylene-based copolymers also have a melt index at 190° C. and 2.16 kg as determined by ASTM D1238 of greater than 5 g/10 min. preferably greater than 10 g/10 min., and more preferably greater than 20 g/10 min.

The alpha-olefin comonomer content in the propylene-based copolymer is at least 5%, preferably 5% to 30%, and most preferably 5% to 15% by weight, and the preferred copolymer is a propylene-ethylene copolymer. The propylene-based copolymers have a melt index (measured at 230° C.) of more than 5 g/10 min., preferably more than 10 g/0 min., and more preferably more than 20 g/10 min., more than 50 g/10 min., or more than 100 g/10 min.

“Blends” may comprise two or more ethylene-based copolymers or two or more propylene-based copolymers, or one or more ethylene-based copolymers with one or more propylene-based copolymers. Where a blend of copolymers is used, the calculated density of the blend should also fall within the above limits, i.e. less than 0.900 g/cm³, but greater than 0.850 g/cm³. For example, a blend of 70% of an ethylene-based copolymer having a density of 0.870 g/cm³ and 30% of a propylene-based copolymer having a density of 0.885 g/cm³ will result in a final blend having a calculated density of 0.875 g/cm³.

Useful single site or metallocene catalyzed ethylene-based polymers are available from, among others, Dow Chemical Company and Exxon Mobil Chemical Company who are producers of single site or constrained geometry catalyzed polyethylenes. These resins are commercially available as the AFFINITY™ and ENGAGE™ from Dow Chemical Co. and EXACT™ polymers from ExxonMobil Chemical.

The single site or metallocene catalyzed propylene-based copolymers are available under the VERSIFY™ brand from The Dow Chemical Company. The manufacture of such polypropylenes is also based on using a metallocene or single site catalyst system and is based on Dow's INSITE™ technology.

The older types of polyethylene or polypropylene can also be used in these formulations along with the OBC polymer. For example, suitable grades of polyethylene can be obtained from Westlake Chemical Co. under the tradename of Epolene™. Examples include Epolene C-10 and C-17 which are polyethylene polymers and C-16 and C-18 which are polyethylene modified with maleic anhydride.

The ratio of the primary or base polymer to the OBC polymer can vary depending on the physical properties and the adhesion required by the finished adhesive formulation. For example, the ratio can be varied to increase or decrease (i) the elasticity of the adhesive composition; (ii) the adhesion of the adhesive composition; (iii) the low temperature resistance of the adhesive composition; (iv) the high temperature resistance of the adhesive composition; (v) the creep resistance of the adhesive composition; (vi) the cohesive strength of the adhesive composition; (viii) the viscosity characteristics of the adhesive composition and/or (ix) the aging characteristics of the adhesive composition. The relative change (increase or decrease) of the above characteristics is measured relative to the adhesive composition without the addition of the secondary polymer. In general, the percentage of the OBC polymer will be lower than the amount of the primary or base polymers) in the formulation.

An important consideration when selecting the base polymer is the molecular weight of the polymer and its impact on the viscosity of the finished adhesive. Since these types of formulations generally contain fairly high levels Of polymer, it is important that the melt index be relatively high to keep the viscosity of the finished adhesive low. The melt index of the base polymer as measured by ASTM D-1238 using a test temperature of 190° C. and a weight of 2.16 kilograms should be greater than 10 grams per minute. More preferably it is greater than 50 and most preferably it is greater than 100. When using a blend of base polymers, the calculated melt index of the blend should be within these ranges.

The hot melt adhesive compositions of the present invention also comprises a solid tackifier which is compatible with the OBC copolymer. Representative resins include the C₅/C₉ hydrocarbon resins, synthetic polyterpenes, rosin, rosin esters, natural terpenes, and the like. More particularly, the useful tackifying resins include any compatible resins or mixtures thereof such as (1) natural and modified rosins including gum rosin, wood rosin, tall oil rosin, distilled rosin, hydrogenated rosin, dimerized rosin, and polymerized rosin; (2) glycerol and pentaerythritol esters of natural and modified rosins, including the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (3) copolymers and terpolymers of natural terpenes, such as styrene/terpene and alpha methyl styrene/terpene; (4) polyterpene resins generally resulting from the polymerization of terepene hydrocarbons, such as the bicyclic monoterpene known as pinene, in the presence of Friedel-Crafts catalysts at moderately low temperatures; also included are the hydrogenated polyterpene resins; (5) phenolic modified terpene resins and hydrogenated derivatives thereof such, for example, as the resin product resulting from the condensation, in an acidic medium, of a bicyclic terpene and a phenol; (6) aliphatic petroleum hydrocarbon resins resulting from the polymerization of monomers consisting primarily of olefins and diolefins; also included are the hydrogenated aliphatic petroleum hydrocarbon resins; and (7) cyclic petroleum hydrocarbon resins and the hydrogenated derivatives thereof. Mixtures of two or more of the above described tackifying resins may be required for some formulations. Also included are the cyclic or acyclic C₅ resins and aromatic modified acyclic or cyclic resins.

More preferably the tackifying resin should have a Ring and Ball softening point (measured by ASTM E28) of at least about 95° C., and preferably between about 95° C. and about 140° C., and most preferably the softening point is between about 95° C. and about 130° C. In general the tackifying resin should be substantially aliphatic to insure compatibility between the resin and the polyolefin base polymer and the OBC polymer.

A preferred tackifier is a hydrogenated aromatic modified dicyclopentadiene resin with a Ring and Ball softening point between about 100° C. to 140° C. The most preferred tackifying resins are fully hydrogenated resins regardless of type like aliphatic or cycloaliphatic hydrocarbon resins such as, Eastotac® H100W, or Sukorez® SU210, a pure aromatic monomer resin such as Regalrez 1126, and DCPD (dicyclopentadiene) resins with no aromatic content such as Escorez 5415.

Also, other preferred tackifying resins are partially hydrogenated aliphatic hydrocarbon resins such as Eastotac H100L and Eastotac H100R, as well as non-hydrogenated aliphatic C5 resins and aromatic modified C5 resins with low aromaticity such as Piccotac 1095 and Piccotac 9095, respectively.

The tackifiers are generally present in the adhesive compositions in an amount greater than the amount of the OBC block copolymer. Within this range, amounts of about 10 to 60% by weight of the composition, preferably about 15 to 50% by weight are utilized, and most preferably about 20 to 50% by weight. Blends of two or more tackifying resins may also be used. For example, a blend of a first tackifying resin and a second tackifying resin that is different than the first tackifying resin may also be employed. From about 0% to about 40% by weight of one or more additional tackifying resins may be blended together with the first tackifying resin if desired.

For end use applications such as case and carton seal or multiwall bag sealing, there will typical be no plasticizer used in the adhesive. If present, the plasticizer would be used in an amount of 10 percent or less, more preferably less than 5 percent. If present, a suitable plasticizer may be selected from the group which not only includes the usual plasticizing oils, such as mineral oil, but also olefin oligomers and low molecular weight polymers, glycol benzoates, as well as vegetable and animal oil and derivatives of such oils. The petroleum-derived oils that may be employed are relatively high boiling temperature materials containing only a minor proportion of aromatic hydrocarbons. In this regard, the aromatic hydrocarbons should preferably be less than 30%, and more particularly less than 15%, by weight, of the oil. Alternately, the oil may be totally non-aromatic. The oligomers may be polypropylenes, polybutenes, hydrogenated polyisoprene, hydrogenated butadiene, or the like having average molecular weights between about 100 and about 10,000 g/mol. Suitable vegetable and animal oils include glycerol esters of the usual fatty acids and polymerization products thereof. Other plasticizers may be used provided they have suitable compatibility. Nyflex 222B, a naphthenic mineral oil manufactured by Nynas Corporation, has also been found to be an appropriate plasticizer. As will be appreciated, plasticizers have typically been employed to lower the viscosity of the overall adhesive composition without substantially decreasing the adhesive strength and/or the service temperature of the adhesive.

Waxes in amounts of 0% to 30% by weight can also be used in the adhesive composition, and are used to reduce the melt viscosity of the hot melt construction adhesives without appreciably decreasing their adhesive bonding characteristics. These waxes also are used to reduce the open time of the composition without affecting the temperature performance.

Among the useful wax materials are:
(1) Low molecular weight, that is, 100-6000 g/mol, polyethylene having a hardness value, as determined by ASTM method D-1321, of from about 0.1 to 120 and ASTM softening points of from about 66° C.° to 120° C.
(2) Petroleum waxes such as paraffin wax having a melting point of from about 130° to 170° F. and microcrystalline wax having a melting point of from about 135° to 200° F., the latter melting points being determined by ASTM method D127-60;
(3) metallocene catalyzed propylene-based wax like those commercialized by Clariant under the name “Licocene”;
(4) metallocene catalyzed wax or single-site catalyzed wax like for example those described in U.S. Pat. Nos. 4,914,253, 6,319,979 or WO 97/33921 or WO 98/03603;
(5) synthetic waxes made by polymerizing carbon monoxide and hydrogen such as Fischer-Tropsch wax; and
(6) polyolefin waxes. As used herein, the term “polyolefin wax” refers to those polymeric or long-chain entities comprised of olefinic monomer units. These materials are commercially available from Westlake Chemical Co. under the trade name “Epolene.”

The wax materials which are preferred to use in the compositions of the present invention have a Ring and Ball softening point of 200° F. to 350° F. As should be understood, each of these waxes is solid at room temperature. Other useful substances include hydrogenated animal, fish and vegetable fats and oils such as hydrogenated tallow, lard, soy oil, cottonseed oil, castor oil, menhadin oil, cod liver oil, etc., and which are solid at ambient temperature by virtue of their being hydrogenated, have also been found to be useful with respect to functioning as a wax material equivalent. These hydrogenated materials are often referred to in the adhesives industry as “animal or vegetable waxes”.

The adhesive also typically includes about 0.1% to about 5% of a stabilizer or antioxidant. The stabilizers which are useful in the hot melt adhesive compositions of the present invention are incorporated to help protect the polymers noted above, and thereby the total adhesive system, from the effects of thermal and oxidative degradation which normally occurs during the manufacture and application of the adhesive as well as in the ordinary exposure of the final product to the ambient environment. Such degradation is usually manifested by a deterioration in the appearance, physical properties and performance characteristics of the adhesive. A particularly preferred antioxidant is Irganox 1010, a tetrakis(methylene(3,5-di-teri-butyl-4-hydroxyhydrocinnamate))methane manufactured by BASF. Among the applicable stabilizers are high molecular weight hindered phenols and multifunctional phenols, such as sulfur and phosphorus-containing phenols. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus providing the phenolic compound with its stabilizing properties.

Representative hindered phenols include:
1,3,5-trimethyl-2,4,6-tris(3-5-di-tert-butyl-4-hydroxybenzyl)benzene;
pentaerythritol tetrakis-3(3,5-di-tert-butyl-4-hydroxyphenyl)propionate;
n-octadecyl-3(3,5-ditert-butyl-4-hydroxyphenyl)propionate;
4,4′-methylenebis(4-methyl-6-tert butylphenol);
4,4′-thiobis(6-tert-butyl-o-cresol);
6-(4-hydroxyphenoxy)-2,4-bis(n-ocytlthio)-1,3,5-triazine;
2,4,6-tris(4-hydroxy-3,5-di-tert-butyl-phenoxy)-1,3,5-triazine;
di-n-octadecyl-3,5-di-tert-butyl-4-hydroxybenzylphosphonate;
2-(n-octylthio)ethyl-3,5-di-tert-butyl-4-hydroxybenzoate; and
sorbitol hexa-(3,3,5-di-tert-butyl-4-hydroxy-phenyl) propionate.

The performance of these stabilizers may be further enhanced by utilizing, in conjunction therewith synergists such as thiodipropionate esters and phosphites. Examples of these include dilauryl thiodipropionate (DLTDP) and tris(nonylphenyl) phosphite (TNPP), respectively.

Up to 25% of optional additives may be incorporated into the adhesive composition in order to modify particular physical properties. These additives may include colorants, such as titanium dioxide and fillers such as talc, calcium carbonate and clay, crosslinking agents, nucleating agents, reactive compounds, fire-retardant mineral or organic agents, as well as ultraviolet light (UV) absorbing agents and UV fluorescing agents. These optional additives are well known in this art.

The adhesive composition useful in the method of the present invention may be produced using any of the techniques known in the art. A representative example of the procedure involves placing all of the substances in a jacketed mixing kettle, and preferably in a jacketed heavy duty mixer of the Baker-Perkins or Day type, and which is equipped with rotors, and thereafter raising the temperature of this mixture to a range of 120° C. to 177° C. It should be understood that the precise temperature to be used in this step would depend on the melting point of the particular ingredients. The resulting adhesive composition is agitated until the polymers completely melt and dissolve. A vacuum is then applied to remove any entrapped air.

The viscosity of the adhesive composition of the present invention is equal to or lower than 50,000 centipoise at 350° F. (177° C.). Preferably, it should be lower than 30,000 centipoise at 350° F. (177° C.) as determined by employing a Brookfield Thermocel or other appropriate viscometer and utilizing the testing techniques which are set forth in ASTM Method D3236-88. The viscosity of the finished adhesive can vary widely depending on the end use of the adhesive. For example, hot melt adhesives used for pinch bottom bag application are generally quite high in viscosity, for example 25,000 centipoise at 350° F. On the other hand, hot melts used for case and carton sealing are typically less than 2000 centipoise at 350° F.

Raw Materials Used in the Examples

Tackifying Resins
Eastotac H130R is a hydrogenated aliphatic hydrocarbon resin with a 130° C. softening point available from Eastman Chemical Co.
Piccotac 9095 is an aromatic modified hydrocarbon resin with a 94° C. softening point available from Eastman Chemical Co.
Escorez 5637 is a hydrogenated aromatic modified dicyclopentadiene resin with a softening point of 130° C. available from ExxonMobil Chemical Co.
Sylvares TR 7115 is a polyterpene resin available from Arizona Chemical Co. with a softening point of 115° C.
Wingtack Extra is an aromatic modified C-5 hydrocarbon resin having a 97° C. softening point available from Cray Valley.
Escorez 5400 is a hydrogenated DCPD resin available from ExxonMobil. Chemical having a softening point of 103° C.
Escorez 5340 is a hydrogenated DCPA resin available form ExxonMobil Chemical with a softening point of 140° C.

Polymers
Epolene C-10 is a polyethylene polymer with a Ring & Ball softening point (ASTM E-28) of 102° C., a melt index (ASTM D-1238, 190° C./2.16 kg) of 2250 and is available from Westlake Chemical Corp.
Epolene C-16 is a maleated polyethylene having a Ring & Ball softening point of 102° C., melt index of 1700 and an acid number of 2 available from Westlake Chemical Corp.
Epolene C-17 is a polyethylene polymer having a Ring & Ball softening point of 133° C. and a melt index of 19 available from Westlake Chemical Corp.
Ateva 1360 is an ethylene vinyl acetate copolymer that has a melt index of 220 g/10 minutes and a vinyl acetate content 13.0%. It is available from Celenese Performance Polymers, Inc.
Ateva 1231 is an ethylene vinyl acetate copolymer having a melt index of 3.0 and a vinyl acetate content of 12%. It is available from Celenese Performance Polymers, Inc.
AT 191A is a low density polyethylene with a melt index of 160 g/10 minutes and a density of 0.911 g/cc. It is available from Celenese Performance Polymers, Inc.
Escorene MV02514 is an ethylene vinyl acetate copolymer with a vinyl acetate content of 14% and a viscosity at 190° C. of 3100 centipoise. It is available from ExxonMobil Chemicals.
Retac 2280 is an amorphous polyalphaolefin polymer containing propylene and ethylene with a viscosity of 8000 centipoise at 190° C. It has a Ring Ball Softening point of 146° C. and is available from Rextac Corp.
AT 190 is a low density polyethylene with a melt index of 70 g/10 minutes (ASTM 1238 125° C./0.325 kg.) and a density of 0.914 g/cc available from Celenese Performance Polymers, Inc.
Vestoplast 792 is an amorphous polyalphaolefin available from Evonik Industries. with a viscosity of 120,000 centipoise at 190° C. and a softening point of 118° C.

Mineral Oil
Calsol 5550 is a napthenic mineral oil available from Calumet Specialty Products and has a viscosity (ASTM D2161) at 100° F. of 510 Saybolt Universal Seconds.

Waxes
Marcus 300 is a low molecular weight polyethylene wax with a DSC Melting point (ASTM D3418) of 116° C. and a molecular weight (Mn) of 1100. It is available from Marcus Oil and Chemical.
104N is a high density polyethylene wax having a softening point of 118° C., a viscosity at 140° C. of 300 centipoise and a density of 0.93 g/cc. It can be purchased from liana Corp.
Viscowax 112 is a polyethylene wax with a softening point of 113° C. (DGF M-III 3), a viscosity of 150 mm̂2/s at 140° C. (DGF M-III 8) and a density of 0.94 (DIN EN ISO 1183 C), The manufacturer is Innospee Chemicals.
PX-100 is available from Baker Petrolite Co. and is a Fischer-Tropsch wax with a melting point (ADTM D-127) of 110° C.

Olefin Block Copolymer
Infuse 9807 is an olefin block copolymer with a melt index of 15 (ASTM 1238, 190° C., 2.16 kg) and a density of 0.866 g/cc (ASTM 792). It is available from Dow Chemical Co.

Antioxidant
Irganox 1010 is a hindered phenolic antioxidant manufactured by BASF.

### DEFINITIONS

“AO” means antioxidant.

“APAO” means amorphous poly alpha olefin.

“Ar mod” means aromatic modified.

“EVA” means ethylene vinyl acetate.

“HC” means hydrocarbon.

“HM” means hot melt.

“OBC” means olefin block copolymer.

“PE” means polyethylene.

“DCPD” means dicyclopentadiene.

The invention provides a hot melt adhesive composition, comprising a blend of the following components for use as a pinch bottom bag adhesive in a multiwall bag application. Table One shows a number of prior art examples compared to a new PE/OBC blend in a pinch bottom bag application.

TABLE ONE
Pinch Bottom Bag Application

| | | Comparative | Comparative | Comparative | |
|---|---|---|---|---|---|
| Raw Material | | Example 1 | Example 2 | Example 3 | Example 1 |
| Eastotac H130R | H2 HC | 19.9 | | | |
| | resin | | | | |
| | Ar mod | | | | |
| Piccotac 909,5 | C5 | | 25.0 | | 30.0 |
| | H2 Ar | | | | |
| | mod | | | | |
| Escorez 5637 | DCPD | | | 32.4 | |
| Epolene C-16 | PE | 37.9 | | | |
| Epolene C-17 | PE | 31.9 | | | |
| Ateva 1360 | EVA | | 50.0 | | |
| Ateva 1231 | EVA | | 14.9 | 26.0 | |
| Ateva 191A | PE | | | | 47.3 |
| Escorene | | | | | |
| MV02514 | EVA | | | 31.4 | |
| Rextac 2280 | APAO | 10.0 | | | |
| Marcus 300 | Wax | | 10.0 | | |
| 104N Hybrid wax | Wax | | | 10.0 | |
| Viscowax 112 | Wax | | | | 10.0 |
| Infuse 9807 | OBC | | | | 12.5 |
| Irganox 1010 | AO | 0.3 | 0.1 | 0.2 | 0.2 |
| Total | | 100 | 100 | 100 | 100 |
| Viscosity at 350° F. | | 25500 | 26000 | 24500 | 24500 |
| Cold temperature | | | | | |
| testing (0° F.) | | Pass | Pass | Fail | Pass |
| High temperature | | | | | |
| testing (140° F.) | | Fail | Fail | Pass | Pass |
| | | Typical | Typical EVA | Typical EVA | New PE/OBC |
| Comments | | PE/APAO blend | based HM | based HM | blend |

In Table One (above) samples of multiwall bag stock were glued together using a bead of hot melt adhesive about ⅛ inch wide that was applied at a temperature of 350° F. using an open time of about one second. After allowing to equilibrate to room temperature for 24 hours, the samples were placed in an incubator oven at 140° F. and also in a freezer at 0° F. After aging for 24 hours at the test temperature, the samples were torn apart by hand and the bond was evaluated. Example One, which uses a blend of polyethylene, tackifying resin and APAO produced a substrate tearing bond at 0° F., but was able to be peeled apart at 140° F. Example Two, which is a blend of EVA, tackifying resin and a high melting point polyethylene wax produced similar results with bond failure at 140° F. Example Three was another blend of EVA, tackifying resin and a polyethylene wax. A tackifying resin with a very high softening point was used to increase the high temperature resistance. This example passed the high temperature test but now cracked apart and failed under cold temperature testing. Example 1 (inventive) uses a polymer blend of polyethylene with an OK polymer. Example provided good bond strength under both low and high temperature testing.

Table Two shows an example of a hot melt glue stick formulation and Table Three shows an example of a case and carton seal formulation using the polyethylene/OBC blend compared to conventional products used currently.

TABLE TWO
Hot Melt Glue Stick

| | | Comparative | Comparative | |
|---|---|---|---|---|
| Raw Material | | Example 1 | Example 2 | Example 1 |
| Sylvares TR | Terpene | | | |
| 7115 | resin | 33 | | |
| Wingtack | Ar mod | | 29.8 | |
| Extra | C5 | | | |
| Piccotac | Ar mod | | | 33 |
| 9095 | C5 | | | |
| AT 191A | PE | 20.1 | | 55 |
| AT 190 | PE | 35.3 | | |
| Epolene C-10 | PE | | 70 | |
| Infuse 9807 | OBC | | | 11.5 |
| Vestoplast | APAO | 11.3 | | |
| 792 | | | | |
| Irganox 1010 | AO | 0.3 | 0.2 | 0.5 |
| Total | | 100 | 100 | 100 |
| Viscosity at | | | | |
| 350° F. | | 42500 | 2000 | 7500 |
| | | Typical PE/ | Straight PE | New PE/ |
| | | APAO | | OBC based |
| Comments | | blend | product | HM |

Example One gave excellent bond strength to a variety of substrates and exhibited better hot tack than the two comparative examples.

TABLE THREE
Case & Carton Seal

| | | Comparative | Comparative | |
|---|---|---|---|---|
| Raw Material | | Example 1 | Example 2 | Example 1 |
| Escorez 5400 | H2 | 30 | 30 | 37.5 |
| | DCPD | | | |
| Escorez 5340 | H2 | | | 9.3 |
| | DCPD | | | |
| Epolene C-10 | PE | 69.1 | 59.1 | 30 |
| Infuse 9807 | OBC | | | 5 |
| PX-100 wax | Wax | | 10 | |
| Viscowax 112 | Wax | | | 12 |
| | Mineral | | | |
| Calsol 5550 | oil | | | .5.3 |
| Irganox 1010 | AO | 0.9 | 0.9 | 0.9 |
| Total | | 100 | 100 | 100 |
| Viscosity | | 1500 cP | 2000 cP | 7500 cP |
| at 350° F. | | | | |
| IOPP testing | | Fails | Fails | Passes |
| at 140° F. | | | | |
| Cold crack | | Cracks | Cracks | Passes |
| at 0° F. | | | | |

In Table Three (above), samples of corrugated stock were bonded together using a bead of adhesive approximately ⅛ inch wide that was applied to the substrate at a temperature of 350° F. with an open time of two seconds. After conditioning for 24 hours at room temperature, samples were placed in an oven at 140° F. and a freezer at 0° F. After aging at 0° F., the bonds were peeled apart by hand and failure mode noted. Both comparative examples showed cracking and failure of the bond line. After 24 hours at 140° F., the samples were also tested using test method T-3006 developed by the Institute of Packaging Professionals, “Suggested Test Method for Determining the Heat Stress Resistance of Hot Melt Adhesives”. To pass this test, a two inch wide bond line of adhesive is required to support a weight of 200 grams for a period of 24 hours. Both Comparative Example 1 and Comparative Example 2 failed this test before the 24 hour limit; while the new Example One passed this test as well as the cold crack test.

1) A hot melt adhesive composition comprising:
a) about 20 to 70 percent by weight of a polyolefin polymer having a melt index of greater than about 5 g/10 minutes using ASTM 1238 at 190° C. with a 2.16 kg weight;
b) about 2 to 50 percent by weight of an olefin block copolymer with a density of from about 0.86 g/cc to about 0.89 glee;
c) about 10 to 60 percent by weight of a tackifying resin with a softening point of from about 95° to about 140° C.; and
d) about 0.1 to about 5 percent by weight of an antioxidant;
and wherein the adhesive composition has a Brookfield viscosity equal to or less than about 50,000 centipoise at 177° C.

2. The composition of claim 1 wherein said composition has a viscosity equal to or less than 30,000 centipoise at 177° C.

3. The composition of claim 1 wherein said composition has a viscosity equal to or less than 25,000 centipoise at 177° C.

4. The composition of claim 1 wherein said tackifying resin has a softening point of from about 95° C. to about 130° C.

5. The composition of claim 1 wherein said tackifying resin has a softening point of from about 100° C. to about 130° C.

6. The composition of claim 1 having about 15% to about 50% by weight of said tackifying resin.

7. The composition of claim 1 having about 20% to about 50% by weight of said tackifying resin.

8. The composition of claim 1 wherein said tackifying resin is selected from the group consisting of aliphatic hydrocarbon resins and their hydrogenated derivatives, hydrogenated cycloaliphatic hydrocarbon resins, aromatic modified aliphatic or hydrogenated cycloaliphatic hydrocarbon resins, aliphatic modified aromatic hydrocarbon resins, partially or fully hydrogenated aromatic hydrocarbon resins, polyterpene and styrenated polyterpene resins.

9. The composition of claim 1 further including up to 10% by weight of a plasticizer.

10. The composition of claim 9 wherein said plasticizer is selected from the group consisting of mineral oil and liquid polybutene.

11. The composition of claim 1 further including up to 30% by weight of a wax.

12. The composition of claim 11 wherein said wax is selected from the group consisting of petroleum waxes, microcrystalline waxes, synthetic waxes and polyolefin waxes.

13. The composition of claim 2 wherein said polyolefin polymer is present in an amount of about 30% to 70% by weight.

14. The composition of claim 1 wherein said polyolefin polymer is present in an amount of about 30% to 60% by weight.

15. The composition of claim 1 wherein said polyolefin polymer has a melt index greater than about 10 g/10 minutes.

16. The composition of claim 1 wherein said polyolefin polymer has a melt index greater than about 20 g/10 minutes.

17. The composition of claim 1 wherein said polyolefin polymer is selected from the group consisting of polyethylene, polypropylene, copolymers of ethylene and propylene, ethylene-acrylic acid copolymers, ethylene-alkyl acrylate or methacrylate copolymers, ethylene-vinyl acetate copolymers, and mixtures of the above polymers.

18. The composition of claim 1 wherein said polyolefin polymer is a homopolymer or copolymer of an α-olefin comprising 2-18 carbon atoms.

19. The composition of claim 18 wherein said α-olefin comprises ethylene.

20. The composition of claim 18 wherein said α-olefin comprises propylene.

21. The composition of claim 1 wherein said olefin block copolymer is present in an amount of about 5% to 30% by weight.

22. The composition of claim 1 wherein said olefin block copolymer is present in an amount of about 5% to 20% by weight.

23. The composition of claim 1 wherein said olefin block copolymer has a melt index of from about 1 g/10 minutes to about 1000 g/10 minutes.

24. The composition of claim 1 wherein said olefin block copolymer has a melt index of from about 1 g/10 minutes to about 100 g/10 minutes.
